(19) United States
(12) Patent Application Publication
(10) Pub. No.: US 2016/0103673 A1
(43) Pub. Date: Apr. 14, 2016

(54) Analytical Software Patch Management

(71) Applicant: International Business Machines Corporation, Armonk, NY (US)

(72) Inventors: Paul Curran, Galway (IE); Bradford A. Fisher, Chapel Hill, NC (US); James K. MacKenzie, Ayrshire (GB); Dominic O'Toole, Headford (IE)

(21) Appl. No.: 14/818,749

(22) Filed: Aug. 5, 2015

Related U.S. Application Data
(63) Continuation of application No. 14/509,534, filed on Oct. 8, 2014.

(51) Int. Cl. G06F 9/445

(52) U.S. Cl. CPC G06F 8/65

(57) ABSTRACT

A mechanism is provided for applying a maximum number of software patches to each computing system in a set of computing systems. A set of computing systems are grouped into a plurality of computing system groups based on characteristics associated with each computing system, the plurality of computing system groups comprising at least two different groups of computing systems that differ in implementation of previous software patches. For each group of computing systems, a set of pending software patches are bundled based on characteristics associated with that group of computing systems thereby forming a plurality of bundles of pending software patches, the plurality of bundles of pending software patches comprise at least two different sets of pending software patches. For the plurality of computing systems, an associated bundle of pending software patches is applied to an associated group of computing systems.

### BACKGROUND

The present application relates generally to an improved data processing apparatus and method and more specifically to mechanisms for applying a maximum number of software patches to a computing system in a minimum amount of time.

A software patch is a piece of software designed to update a computer program or data supporting the computer program, to fix or improve the computer program. This includes, for example, fixing security vulnerabilities and other bugs, and/or improving the usability or performance. Though meant to fix problems, poorly designed software patches may sometimes introduce new problems. In some special cases updates may knowingly break the functionality, for instance, by removing components for which the update provider is no longer licensed or disabling a device.

Software patch management is the process of using a strategy and plan of which software patches to which computing systems at a specified time. The specified time in which software patches are applied to some computing systems, such as a server that provides business services, is referred to as a maintenance window. Maintenance windows are important for such computing systems because the maintenance windows define time periods when the computing systems are not running in production, so activities may be performed that do not impact the business services which the computing systems support. Thus, a maintenance window is a set period of time whereby a computing system that provides business services is taken off line, has one or more software patches applied, is configured to support the new software patches, and is restarted.

### SUMMARY

In one illustrative embodiment, a method, in a data processing system, is provided for applying a maximum number of software patches to each computing system in a set of computing systems in a maintenance window. The illustrative embodiment groups a set of computing systems into a plurality of computing system groups based on characteristics associated with each computing system, the plurality of computing system groups comprising at least two different groups of computing systems that differ in implementation of previous software patches. For each group of computing systems, the illustrative embodiment bundles a set of pending software patches based on characteristics associated with that group of computing systems thereby forming a plurality of bundles of pending software patches, the plurality of bundles of pending software patches comprising at least two different sets of pending software patches. For the plurality of computing systems, the illustrative embodiment applies an associated bundle of pending software patches to an associated group of computing systems.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a function block diagram of such an analytic software patch management mechanism in accordance with an illustrative embodiment;

FIG. 4 depicts a flow diagram of the initial operation performed by an analytic software patch management mechanism in accordance with an illustrative embodiment; and

FIG. 5 depicts a flow diagram of the operation performed by an analytic software patch management mechanism after an initial run in accordance with an illustrative embodiment.

### DETAILED DESCRIPTION

As stated previously, the specified time in which software patches are applied to computing systems that provide business services is referred to as a maintenance window, which is a set period of time whereby a computing system that provides business services is taken off line, has one or more software patches applied, is configured to support the new software patches, and is restarted.

Software patches may be applied to different machines at different rates, the different rates being influenced by various factors that indicate how quickly the software patches are applied, such as, for example, computing system specification or characteristics (processor speed, load, amount of random access memory (RAM), etc.) and network bandwidth (time required) for the software patches to be downloaded to the target computing system. In accordance with the illustrative embodiments, the computing system specification may indicate, for processor speed, whether the processor is a 3.0 Ghz processor, a 1.5 Ghz processor, a 500 Mhz, etc., such that the illustrative embodiment would recognize that software patches may be applied to a 3.0 Ghz processor roughly twice as fast as a 1.5 Ghz processor and software patches may be applied to a 1.5 GHz processor three times as fast as a 500 Mhz processor. Additionally, the computing specification of a load on the computing system may be in the form of a percentage of CPU utilization of a given time period. That is, for example, a processor that is being utilized at an average of 70% of its capacity over a 5 minute time period may identify a 70% load. In a computing system that has multiple processors, the load may be the average of the utilization on each of the processors. Further, the computing specification may indicate the amount of RAM the computing system is equipped with, for example, 4 GB, 8 GB, 16 GB, etc. Similar computing system specifications may be provided for other features of the computing system.

Additionally, resource restrictions may also impact the application of software patches, for example, if there is a limit on the number of open communication connections from a software patch distribution server, then some type of batching (of target computing systems) must be applied. Further, the importance of the various software patches must be taken into account, such that the most critical software patches are applied first in a maintenance window to ensure mitigation of any issues that may occur by not having enough time in the maintenance window to apply the critical software patches. While software patches may be prefetched to a computing system ahead of a maintenance window, so that the software patches are already available on the computing system at the start of the maintenance window, some computing systems that support business services do not allow operations, such as downloads, during times when the computing system is in production. This restriction on such operation may be due to the sensitive nature of the work the computing system is performing or may be due to issues the download could cause during production time with memory usage, processor usage, or the like, on the computing system, thereby impacting the overall performance of the business services. Therefore, sequencing of software patches, where one software patch must be applied before another software patch, adds a further complication.

During maintenance windows, which are typically short, exactly which software patches are applied and in which order the software patches are applied are currently determined manually. That is, an information technology (IT) individual, such as an administrator, manually determines a list of software patches to apply and an order in which to apply the patches, with, generally, little knowledge of how each of the underlying specification of the computing system, network bandwidth to the computing system, resource restrictions of the computing system, and criticality of each of the software patches required for the computing system interact with each other. That is, while an IT individual may know each of the underlying specification, network bandwidth, resource restrictions, and critically of the software patches individually, the IT individual may not be able to manually discern the interaction of these computer system and software patches characteristics in order to achieve an optimal patch rate. That is, the individual may be judging the potential throughput based on their own past experience, which is not optimized.

It is a common occurrence that not all software patches are applied to a computing system machine during a single maintenance window. Thus, IT individuals apply as many software patches as possible in one maintenance window and for a next maintenance window to apply more software patches. However, since maintenance windows are typically weeks apart for key production computing systems, putting off more software patches that are manually deemed less critical or not having enough time to apply, may leave the computing systems vulnerable to security attacks and other issues when critical software patches for, as an example, security, operating system, and applications are not applied in a timely manner.

Furthermore, software patches are generally applied to multiple computing systems at one time during a maintenance window, which is referred to as batching. When batching computing systems and sequencing software patches, software patches generally proceeds at the rate of the slowest computing system of the computing systems in the batch. If this additional level of concern is not considered by the IT professional, the IT professional may not be aware of which software patches will potentially be applied during a specific maintenance window. That is, for example, if ten software patches are scheduled to be applied during a given maintenance window to ten computing systems, but, for example, one of the computing systems has a decreased network bandwidth due to a faulty network connector, then, since only five software patches are applied to the faulty computing system, only five software patches are applied to the other nine computing systems as well.

Therefore, the illustrative embodiments provide mechanisms for applying a maximum number of software patches to a computing system in a minimum amount of time. Using an analytics based approach, the mechanisms automatically group a set of software patches and a set of target computing systems based on historical and real-time data to receive the set of software patches to ensure maximum application of software patches across a maximum number of target computing systems in a minimum amount of time. Additionally, external events are monitored and processed to further improve the trustworthiness of the analytical data.

Before beginning the discussion of the various aspects of the illustrative embodiments, it should first be appreciated that throughout this description the term “mechanism” will be used to refer to elements of the present invention that perform various operations, functions, and the like. A “mechanism.” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure, or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

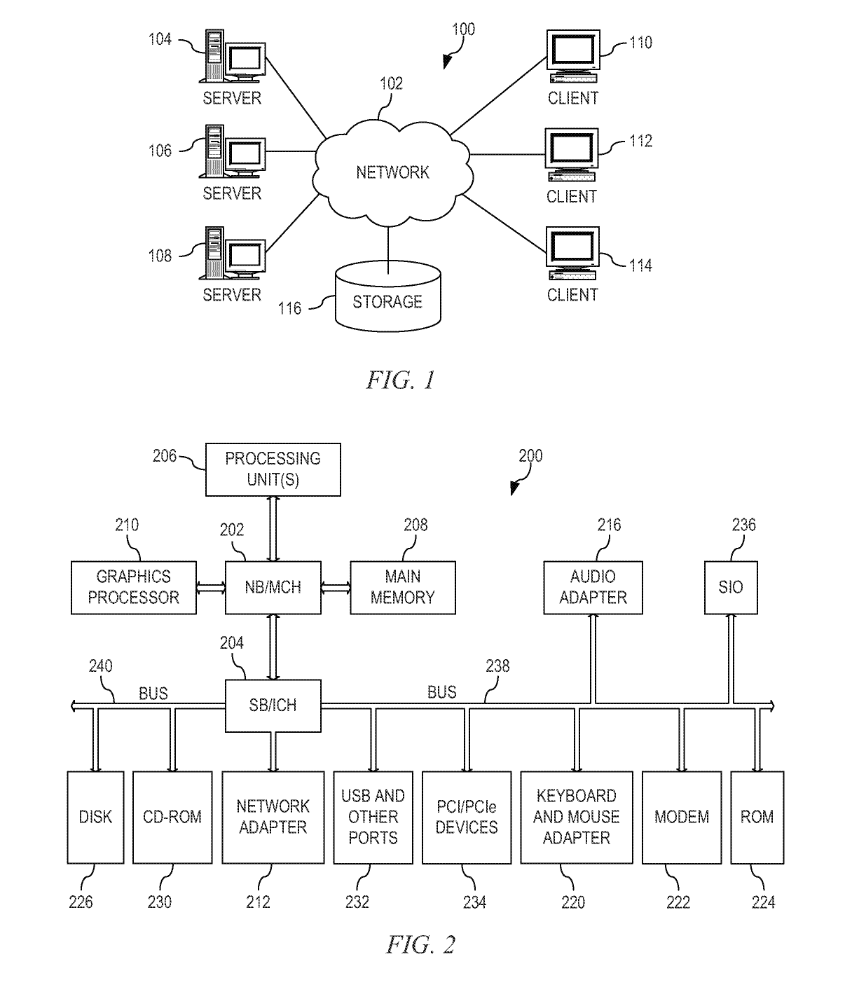

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, servers 104, 106, and 108 are connected to network 102 along with storage unit 116. In addition, clients 110, 112, and 114 are also connected to network 102. These clients 110, 112, and 114 may be, for example, personal computers, network computers, or the like. In the depicted example, servers 104, 106, and 108 provide business services to the clients 110, 112, and 114. Clients 110, 112, and 114 are clients to servers 104, 106, and 108 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as server 104 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

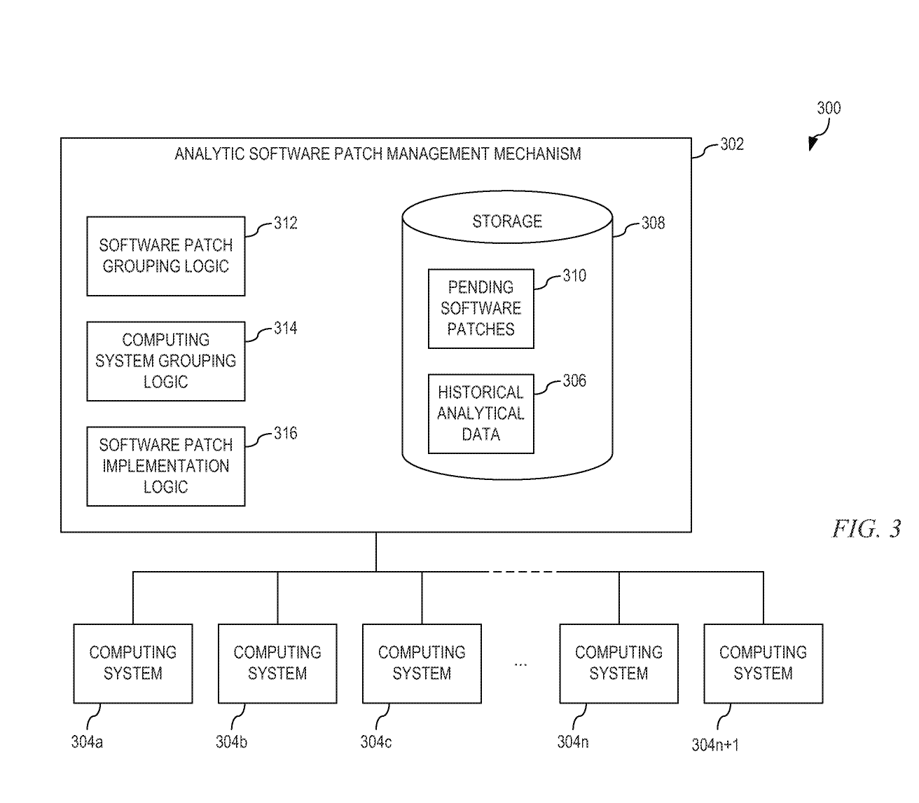

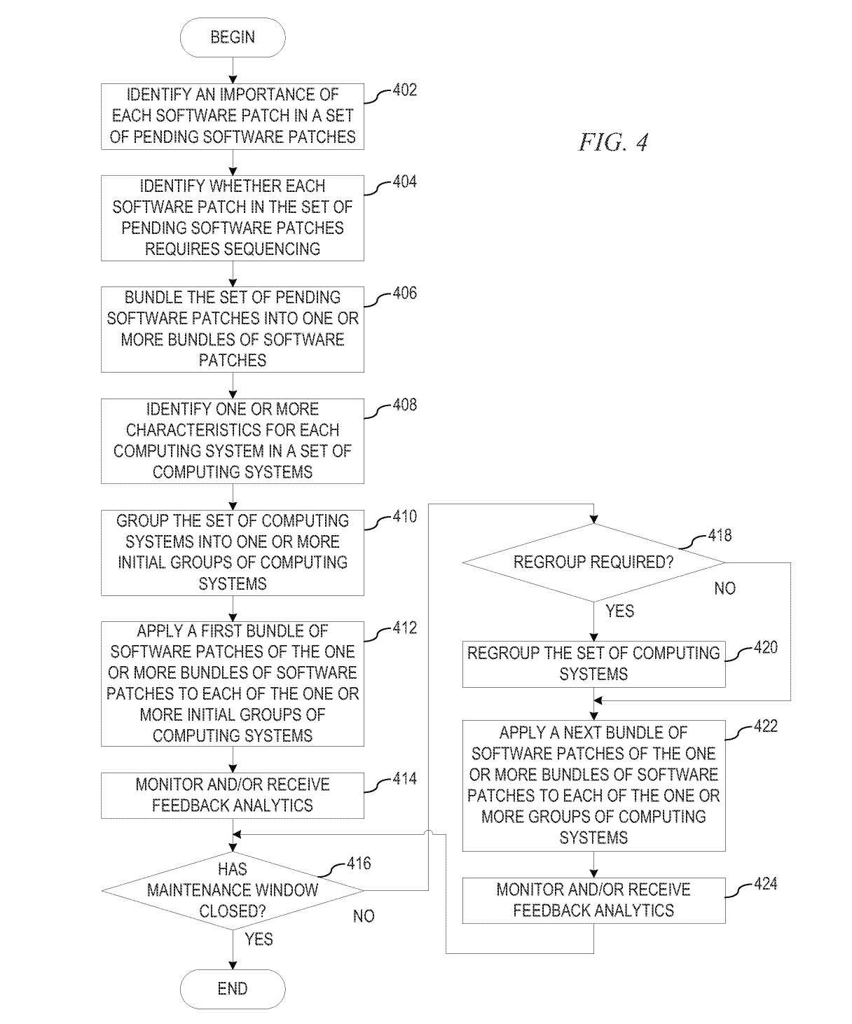

In order to analytically manage software patches, the illustrative embodiment provide an analytic software patch management mechanism for collecting and analyzing past performance of software patches and computing systems and using this data to build optimal sequences of software patches and optimal batches of target computing systems. FIG. 3 depicts a function block diagram of such an analytic software patch management mechanism in accordance with an illustrative embodiment. The functional block diagram of FIG. 3 may be implemented, for example, by one or more of the computing devices illustrated in FIG. 1 and/or data processing system 200 of FIG. 2. Data processing system 300 comprises analytic software patch management mechanism 302 coupled to a plurality of computing systems 304a-304n software patch managed by analytic software patch management mechanism 302.

As will be described in the FIG. 3, analytic software patch management mechanism 302 may operate with or without historical analytical data 306, stored in storage 308, in order to manage the implementation of software patches across the plurality of computing systems 304a-304n. That is, initially, no historical data may exist with regard to how software patches have been implemented on the plurality of computing systems 304a-304n. Therefore, analytic software patch management mechanism 302 may utilize computing system characteristics associated with the plurality of computing systems 304a-304n, such as processor speed, amount of random access memory (RAM), or the like, to implement software patches across the plurality of computing systems 304a-304n. However, once historical analytical data 306 is available after at least one software patch has been implemented on each of the plurality of computing systems 304a-304n, analytic software patch management mechanism 302 may utilize not only computing system characteristics associated with the plurality of computing systems 304a-304n but also historical analytical data 306 to implement software patches across the plurality of computing systems 304a-304n.

Therefore, in one embodiment where no historical analytical data 306 exists, as analytic software patch management mechanism 302 is initialized for the first time, for example, an initial use, an initial run, or the like, analytic software patch management mechanism 302 has no data regarding computing systems 304a-304n or software patches that have been applied to computing systems 304a-304n. Hence, in applying a set of software patches to computing systems 304a-304n for the first time, analytic software patch management mechanism 302 identifies the importance of each software patch in a set of pending software patches 310, stored in storage 308. That is, analytic software patch management mechanism 302 determines whether each software patch in the set of pending software patches 310 is critical, major, minor, or the like, as part of a bundle definition as well as any sequencing required by one or more software patches, i.e. one software patch must be applied before another software patch. The importance and/or a complexity of the software patch as well as any required sequencing may be identified by the developer(s) and/or manufacturer who created the software patch, time(s) required to implement the software patch on one or more test systems, and the like.

With the importance of each software patch in the set of pending software patches 310 identified, software patch grouping logic 312 within analytic software patch management mechanism 302 bundles the set of pending software patches 310 into one or more bundles of software patches based on their importance and sequencing. Analytic software patch management mechanism 302 bundles the software patches such that each bundle of software patches in the one or more bundles does not comprise all software patches in the set of pending software patches 310. Software patch grouping logic 312 initially utilizes smaller bundles of software patches because analytic software patch management mechanism 302 comprises no historical analytical data 306 on how previous software patch implementations have occurred on each of computing systems 304a-304n.

Additionally, since analytic software patch management mechanism 302 comprises no historical analytical data 306 on how previous software patch implementations have occurred on each of computing systems 304a-304n, computing system grouping logic 314 within analytic software patch management mechanism 302 groups computing systems 304a-304n into one or more initial groups of computing systems. Computing system grouping logic 314 groups computing systems 304a-304n such that each initial group of the one or more initial groups formed by computing system grouping logic 314 does not comprise all computing systems in computing systems 304a-304n. For example, if computing system A has a 1.5 GHz processor and 4 GB of RAM, computing system B has a 2.0 GHz processor and 8 MB of RAM, computing system C has a 3.0 GHz processor and 8 GB of RAM, and computing system D has a 500 MHz processor and 4 GB of RAM, computing system grouping logic 314 may initially group computing systems A and B together and computing systems C and D together. Computing systems A and B may be grouped together because computing system grouping logic 314 estimates that each of computing system A and B will be able to implement the software patches based on their processor speeds which are close in range. Computing system C and D are grouped together because, while the processor speeds are not close in range, the processor speed of computing system C indicates that the computing system C will implement the software patches faster thereby allowing more time for computing system D to implement its software patches.

Depending on the number of computing systems in computing systems 304a-304n, computing system grouping logic 314 may utilize predefined limits that indicate a number of computing systems that are allowed in each group. While computing system grouping logic 314 may not be able to initially group computing systems 304a-304n based on historical analytical data 306 on how previous software patch implementations have occurred on each of computing systems 304a-304n, computing system grouping logic 314 may have access to computing system characteristics, such as processor speed, amount of random access memory (RAM), or the like, of each of computing systems 304a-304n. If the computing system characteristics are available, computing system grouping logic 314 may utilize the computing system characteristics to group computing systems 304a-304n into the initial one or more groups of computing systems. If the computing system characteristics are not available, computing system grouping logic 314 may group computing systems 304a-304n into the initial one or more groups of computing systems based on an arbitrary factor, such as, for example, the manufacturer of the computing system, location of the computing system, or network on which the computing system operates.

Once the one or more bundles of software patches and the one or more groups of computing systems are formed, software patch implementation logic 316 within analytic software patch management mechanism 302 applies a first bundle of software patches of the one or more bundles of software patches to each of the one or more initial groups of computing systems. In applying the first bundle of software patches to each of one or more initial groups of computing systems, software patch implementation logic 316 monitors and/or receives feedback analytics as to the application each of the software patches in the first bundle of software patches to each computing systems. For each computing system, the feedback analytics may include, for example, time to install each software patch, network bandwidth, workload on the computing system, or the like. Software patch implementation logic 316 stores the feedback analytics in historical analytical data 306.

Thus, as an example, if software patch implementation logic 316 applies software patch X to each of computing systems A-D, where computing systems A and B are grouped together and computing system C and D, then software patch implementation logic 316 may receive, for example, the following feedback analytics:

| | Time to apply software |
|---|---|
| Computing system | patch X (mins) |
| A | 15 |
| B | 20 |
| C | 10 |
| D | 40 |

With such received feedback analytics, computing system grouping logic 314 analyzes the data and regroups computing systems 304a-304n so that computing systems that had the first bundle of software patches applied faster are grouped together and the computing systems that had the first bundle of software patches applied slower are grouped together. Computing system grouping logic 314 may utilize a predefined threshold to identify those computing systems that are deemed to have the first bundle of software patches applied faster opposed to those computing systems that are deemed to have the first bundle of software patches applied slower. Depending on the number of computing systems in computing systems 304a-304n, computing system grouping logic 314 may again utilize predefined limits that indicate a number of computing systems that are allowed in each group. However, based on the feedback analytics, computing system grouping logic 314 regroups computing systems 304a-304n so that computing systems that had the first bundle of software patches applied faster are grouped into one or more groups separate from computing systems that had the first bundle of software patches applied slower, which computing system grouping logic 314 groups into other one or more groups.

Therefore, in keeping with the example above, computing system grouping logic 314 would regroup the computing systems so that the faster computing systems, computing systems A and C, are in a first group and the slower computing systems, computing systems B and D, are in a second group. Software patch implementation logic 316 then applies a second bundle of software patches of the one or more bundles of software patches to each of the one or more groups of computing systems. Software patch implementation logic 316 monitors and/or receives feedback analytics as to the application each of the software patches in the second bundle of software patches to each computing systems, which software patch implementation logic 316 stores the feedback analytics in historical analytical data 306.

Again, computing system grouping logic 314 analyzes the data and regroups computing systems 304a-304n so that computing systems that had both the first and second bundles of software patches applied faster are grouped together and the computing systems that had the first and second bundles of software patches applied slower are grouped together. Analytic software patch management mechanism 302 continues to perform application of as many bundles of software patches as possible and regrouping of computing systems 304a-304n in the initial maintenance window in order to gather as much historical analytical data 306 for use in a next maintenance window.

Thus, in keeping with the example above, if three software patches X, Y, and Z are implemented in the initial software window, then software patch implementation logic 316 may receive, for example, the following feedback analytics:

| | Time to apply | Time to apply | Time to apply |
|---|---|---|---|
| Computing system | patch X (mins) | patch Y (mins) | patch Z (mins) |
| A | 15 | 20 | 40 |
| B | 20 | 40 | 70 |
| C | 10 | 15 | 25 |
| D | 40 | 60 | 90 |

From this feedback analytics, analytic software patch management mechanism 302 identifies computing system C as being able to install software patches the fastest and computing system D as being able to install software patches the slowest. Further, analytic software patch management mechanism 302 formulates estimated times to apply future pending software patches. That is, for example, for software patches with similar characteristics to software patch Z, which is more complex then software patch X, analytic software patch management mechanism 302 estimates a time to apply patches with similar characteristics to software patch Z as approximately the time it required to apply software patch Z. The characteristics associated with any particular software patch may include, but are not limited to, the particular application or software that the patch is directed to, the complexity of the software patch as identified by the developer(s) and/or manufacturer who created the software patch, time(s) required to implement the software patch on one or more test systems, and the like.

Analytic software patch management mechanism 302 utilizes information gathered from any previous maintenance windows to estimate the time that will be required for each software patch in the set of pending software patches 310, i.e. those software patches that have not previously been installed on one or more of computing systems 304a-304n or any new software patches to be installed on one or more of computing systems 304a-304n. Thus, analytic software patch management mechanism 302 may determine, for example, that software patches U, V, and W will take approximately the same amount of time to install as software patches X, Y, and Z, respectively.

In preparation for a next maintenance window, which, for example, is a 90-minute maintenance window, computing system grouping logic 314 may group computing systems A-D into three groups due to the 90-minute maintenance window and software patches U, V, and W estimated to take approximately the same amount of time to install as previously installed software patches X, Y, and Z, respectively. That is, computing systems A and C were able to install software patches X, Y, and Z; therefore, computing system grouping logic 314 determines that computing systems A and C would be able to install software patches U, V, and W in approximately 75 minutes and 50 minutes, respectively, based on the recorded times to install software patches X, Y, and Z. Furthermore, computing system grouping logic 314 would group computing system B separately because computing system B would be able to install software patches U and V or software patches U and W in approximately 60 minutes and 90 minutes, respectively, based on the recorded times to install software patches X, Y, and Z. Finally, computing system grouping logic 314 would group computing system D separately because computing system D would only be able to install software patch U or software patch V or software patch W in approximately 40 minutes, 60 minutes, and 90 minutes, respectively, but not in combination based on the recorded times to install software patches X, Y, and Z

In continued preparation for the next maintenance window, software patch grouping logic 312 now determines the complexity of the software patches that will be applied to each group of computing systems by taking into consideration the run time on each group of computing systems, the importance of each of pending software patches, any sequencing required by one or more software patches, how long the software patch has been waiting to be implemented, or the like. As one example, software patch grouping logic 312 may choose which software patches to bundle together based on, for example, importance of the software patch first and the speed (time) required to install the software patch second. This is only one example, of how software patch grouping logic 312 may determine which software patches to bundle together for individual groups of computing systems. The illustrative embodiments recognize that software patch grouping logic 312 may bundle pending software patches together based on any set of priorities without departing from the spirit and scope of the invention. The priorities with which software patch grouping logic 312 determines how to bundle software patches together may be based on a set of rules that are predefined and require thresholds to be met. That is, even though a critical software patch is pending, one exemplary rule may state that, if a pending software patch has been waiting for more than two maintenance windows, that software patch should be applied before any other software patch.

Using the example above where software patch grouping logic 312 may choose which software patches to bundle together based on importance of the software patch first and the speed (time) required to install the software patch second and considering, for example, that software patch W is marked as critical, software patch V is marked as major, and software patch U is marked as minor, software patch grouping logic 312 may group together software patches as follows:

| Computing system | Patch(es) to apply | Notes |
|---|---|---|
| A | W, V, U | |
| B | W and V | Critical and minor |
| C | W, V, U | |
| D | W | Critical |

Thus, software patch grouping logic 312 determines that the above software patches are to be applied in the 90-minute maintenance window, ensuring more critical software patches are applied first to ensure they had the best chance at being successfully applied during the 90-minute maintenance window.

Software patch implementation logic 316 within analytic software patch management mechanism 302 then applies the bundles of software patches as identified by software patch grouping logic 312 to each of the one or more associated groups of computing systems as identified by computing system grouping logic 314. Software patch implementation logic 316 again monitors and/or receives feedback analytics as to the application of each of the software patches as applied to each computing system. Analytic software patch management mechanism 302 continues to analyze the feedback analytics as they arrive in order to determine whether the best execution path is being followed. As an example, if analytic software patch management mechanism 302 determines that it is taking longer than estimated to install software patch W on computing system B, then software patch grouping logic 312 may change the software bundle for computing system B to just apply software patch W if it is determined that there would not be enough time to install software patch V. As another example, if analytic software patch management mechanism 302 determines that application of software patch W is going faster than estimated on computing system D, then software patch grouping logic 312 may change the software bundle for computing system D to add software patch V if it is determined that there would be enough time to install software patch V.

When a net computing system is added to computing systems 304a-304n, i.e. computing system 304n+1, no historical data exists in historical analytical data 306 and thus analytic software patch management mechanism 302 will not have analytics with which to identify how to group computing system 304n+1 or which software patches to bundle for application to computing system 304n+1. Thus, analytic software patch management mechanism 302 analyzes the configuration (CPU, memory, disk, network, etc.) associated with computing system 304n+1 to give an estimation of its potential capability. Analytic software patch management mechanism 302 identifies the potential capability of computing system 304n+1 by comparing computing system 304n+1 to other computing systems in computing systems 304a-304n with similar characteristics. Based on this comparison, computing system grouping logic 314 groups computing system 304n+1 with other ones of computing systems 304a-304n having similar characteristics and software patch grouping logic 312 bundles software patches together based on bundles created for other ones of computing systems 304a-304n having similar characteristics. Once an initial set of software patches are applied to computing system 304n+1, software patch implementation logic 316 receives feedback analytics for computing system 304n+1 which is then stored in historical analytical data 306. Analytic software patch management mechanism 302 then identifies a speed at which the software patches were installed on computing system 304n+1 and formulates estimated times to apply future software patches. Thus, analytic software patch management mechanism 302 uses the analytic data collected to further arrange what software patches are applied to computing system 304n+1 in subsequent maintenance windows.

In addition to the analytics received from computing systems 304a-304n, as well as computing system 304n+1 if added, analytic software patch management mechanism 302 also receives indications from one or more external sources, such as, for example, an IT administrator, external database, or external application, with regard to external events, such as, for example, a transformational event, a transient event, or a modification event. A transformational event is an event causing the re-computation of the entire set of analytical data in historical analytical data 306 for a particular computing system. For example, if a particular computing system being targeted has previously had a hardware failure and new CPUs and/or disks are added to the computing system, then all previous analytic data for the particular computing system in historical analytical data 306 is invalid and the analytics for a particular computing system need to be regenerated. Upon indication of such a transformational event, analytic software patch management mechanism 302 would purge all analytics in historical analytical data 306 for the particular computing system and treat the particular computing system as a new computing system.

A transient event is an event that may occur before, during, or after an application of one or more software patches that causes a set of analytics gathered at that point in time for the particular computing system to become unreliable and/or invalid. For example, if an external application reports failure of communication connections for a certain period, then any analytic data collected during this time period should be considered invalid. Upon indication of such a transient event, analytic software patch management mechanism 302 would purge any analytics gathered during the indicated time frame in historical analytical data 306 for the particular computing system and utilize only the remaining analytic data to determine grouping of computing systems and bundling of software patches.

A modification event is a simple event for which a correction factor may be used to adjust the analytics for a particular computing system. For example, if high processor usage is normally high on a particular computing system when a bundle of software patches is applied, the analytics may have been collected while the machine was busy. Therefore, at a later stage while preparing a software patch distribution strategy, analytic software patch management mechanism 302 would determine that the processor load has reduced, for example, by 20%. Upon indication of the modification event, analytic software patch management mechanism 302 may apply a linear formula to the analytical data in order to account for the fact that the particular computing system is actually 20% faster and, thus, any applied software patch would be installed 20% quicker. Analytic software patch management mechanism 302 may apply the adjustment to the predicted installation time.

If any of the external events described above are received by analytic software patch management mechanism 302, in preparing for a next maintenance window, analytic software patch management mechanism 302 analyzes the event indications in addition to the already stored historical analytical data 306 in order that any of the set of pending software patches 310 that are to be applied during the maintenance window are tailored to meet the existing conditions. For example, if it is determined that the network is overloaded, communication connections are restricted, or the like, and the target software patches require large downloads, analytic software patch management mechanism 302 may revise the software patching plan to prioritize software patches with the most importance and with the smallest downloads.

As described previously, if analytic software patch management mechanism 302 determines that it is taking longer than estimated to install a particular software patch in a bundle of software patches on a particular computing system, then software patch grouping logic 312 may change the software bundle for the particular computing system to apply only the current software patch or some subset of the original bundle of software patches for the particular computing system. Similarly, if analytic software patch management mechanism 302 detects or receives indication of an external event, such as, for example, a transformational event, a transient event, or a modification event, or some other event, during the maintenance window, then software patch grouping logic 312 may change the software bundle for one or more computing systems affected by the external event to apply a subset of the original bundle of software patches for those one or more computing systems. The other event in addition to the transformational event, transient event, or modification event may include, but are not limited to, detection of a change of software or hardware on a computing system, power outages, periods of unusually high network activity, a network failure, or the like.

Thus, analytic software patch management mechanism 302 provides for installing a plurality of software patches on a plurality of computing systems based on, for example, characteristics associated with each of the computing systems, network bandwidth associated with each of the computing systems, resource restrictions associated with each of the computing systems as well as analytic software patch management mechanism 302, previous execution of similar software patches on similar commuting systems, the importance of each of pending software patches, any sequencing required by one or more software patches, and/or how long the software patch has been waiting to be implemented. Therefore, after analytic software patch management mechanism 302 has executed a number of software patches on the plurality of computing systems, analytic software patch management mechanism 302 has an additional capability to estimate a length of a maintenance window for each computing system. Thus, in a second embodiment where historical analytical data 306 exists, analytic software patch management mechanism 302 has access to historical analytical data 306 as well as a set of pending software patches. By correlating the set of pending software patches to previously installed software patches and using historical analytical data 306, analytic software patch management mechanism 302 may plan a maintenance window and select the list of software patches to install on each computing system in the plurality of computing systems. Therefore, analytic software patch management mechanism 302 can estimate, based on the selected software patches for each particular computing system, an optimum length of the maintenance window (shorter or longer) during which the maximum amount of software patches will be applied.

Accordingly, the analytics in historical analytical data 306 offer an insight into computing systems 304a-304n. For example, historical analytical data 306 gathered by analytic software patch management mechanism 302 identifies which computing systems install software patches faster, which is utilized by computing system grouping logic 314, which may reduce the maintenance window for these servers and improve the business services provided by these computing systems, at least by reducing down time. As another example, for those computing systems that install software patches slower, analytic software patch management mechanism 302 may be able to identify the need for upgrades to or maintenance for those computing systems. Thus, analytic software patch management mechanism 302 of the illustrative embodiments provide for enhancement to the overall rate of software patch application to computing systems 304a-304n.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

FIG. 4 depicts a flow diagram of the initial operation performed by an analytic software patch management mechanism in accordance with an illustrative embodiment. As the operation begins, the analytic software patch management mechanism identifies an importance of each software patch in a set of pending software patches (step 402). For example, whether the software patch is critical, major, minor, or the like. The analytic software patch management mechanism also identifies whether each software patch in the set of pending software patches requires sequencing (step 404). The importance and/or a complexity of a particular software patch as well as any required sequencing may be identified by the developer(s) and/or manufacturer who created the software patch, time(s) required to implement the software patch on one or more test systems, and the like. The analytic software patch management mechanism then bundles the set of pending software patches into one or more bundles of software patches based on their importance and sequencing, if required, such that each bundle of software patches does not comprise all software patches in the set of pending software patches (step 406).

The analytic software patch management mechanism then identifies one or more characteristics for each computing system in a set of computing systems to which one or more of the set of pending software patches are to be deployed to (step 408). Based on these characteristics, the analytic software patch management mechanism groups the set of computing systems into one or more initial groups of computing systems, such that each initial group of the one or more initial groups that are formed does not comprise all computing systems in the set of computing systems (step 410). Once the one or more bundles of software patches and the one or more groups of computing systems are formed, the analytic software patch management mechanism applies a first bundle of software patches of the one or more bundles of software patches to each of the one or more initial groups of computing systems (step 412). In applying the first bundle of software patches to each of one or more initial groups of computing systems, the analytic software patch management mechanism monitors and/or receives feedback analytics, which are stored in an historical analytics data structure, as to the application of each of the software patches in the first bundle of software patches to each computing system (step 414).

After the first bundle of software patches is applied to each computing system, the analytic software patch management mechanism determines whether the maintenance window has closed (step 416). If at step 416 the maintenance window has not closed, then the analytic software patch management mechanism determines, based on the received feedback analytics, whether the set of computing systems need to be regrouped (step 418). That is, based on the speed at which each of the computing systems installed the software patches in the first bundle of software patches, the analytic software patch management mechanism determines whether a regrouping needs to be performed so that computing systems that had the first bundle of software patches applied faster are grouped together and the computing systems that had the first bundle of software patches applied slower are grouped together. The analytic software patch management mechanism may utilize a predefined threshold to identify those computing systems that are deemed to have the first bundle of software patches applied faster opposed to those computing systems that are deemed to have the first bundle of software patches applied slower. If at step 418 the analytic software patch management mechanism determines that regrouping needs to be performed based on the feedback analytics, then analytic software patch management mechanism regroups the set of computing systems so that computing systems that had the previous bundle(s) of software patches applied faster are grouped into one or more groups separate from computing systems that had the previous bundle(s) of software patches applied slower (step 420).

From step 420 of if at step 418 the analytic software patch management mechanism determines that no regrouping needs to be performed based on the feedback analytics, the analytic software patch management mechanism then applies a next bundle of software patches of the one or more bundles of software patches to each of the one or more groups, either initial or regrouped, of computing systems (step 422). The analytic software patch management mechanism again monitors and/or receives feedback analytics as to the application of each of the software patches in the next bundle of software patches to each computing system (step 424), with the operation proceeding to step 416 thereafter. If at step 416 the maintenance window has closed, then the operation terminates for the initial maintenance window.

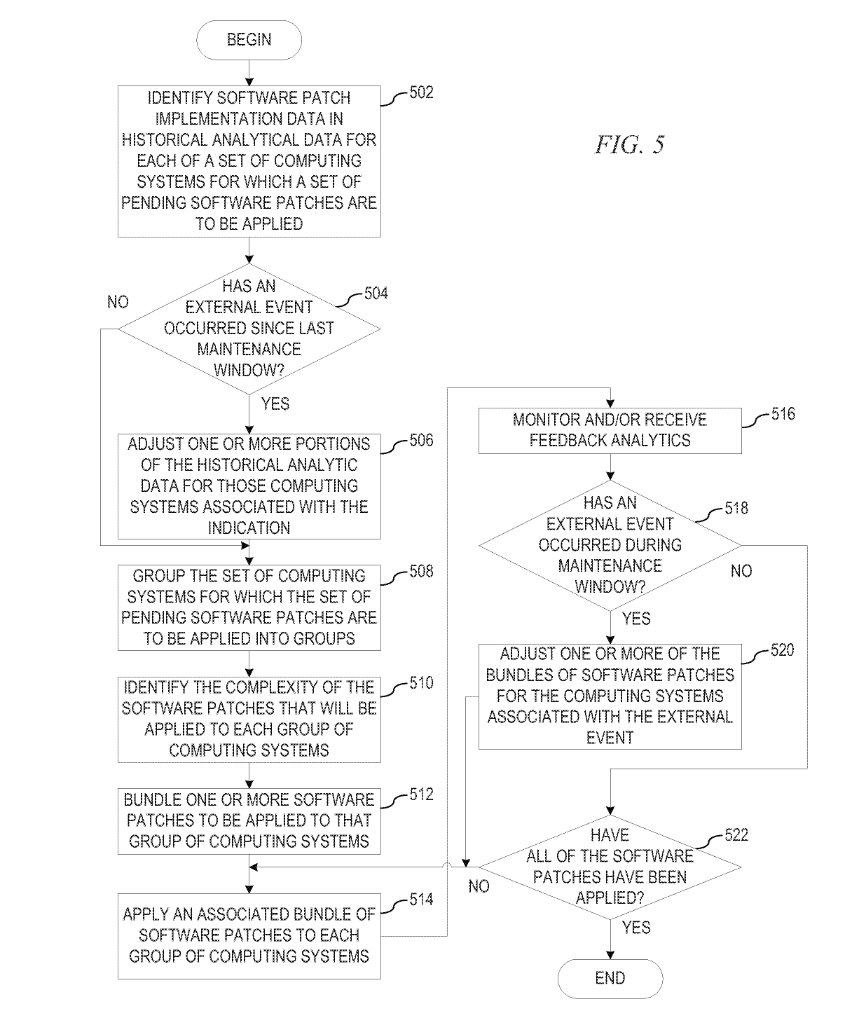

FIG. 5 depicts a flow diagram of the operation performed by an analytic software patch management mechanism after an initial run in accordance with an illustrative embodiment. As the operation begins, the analytic software patch management mechanism identifies software patch implementation data in historical analytical data for each of a set of computing systems for which a set of pending software patches are to be applied (step 502). The analytic software patch management mechanism then determines whether one or more external events have been indicated since the last maintenance window, such as, for example, a transformational event, a transient event, or a modification event (step 504). If at step 504 one or more external events are indicated, the analytic software patch management mechanism adjust one or more portions of the historical analytic data for those computing systems associated with the indication (step 506). From step 506 or if at step 504 no external event is indicated, the analytic software patch management mechanism groups the set of computing systems for which the set of pending software patches are to be applied into groups using the identified historical analytical data (step 508). The analytic software patch management mechanism then identifies the complexity of the software patches that will be applied to each group of computing systems (step 510) taking into consideration the run time on each group of computing systems, the importance of each of pending software patches, any sequencing required by one or more software patches, how long the software patch has been waiting to be implemented, or the like. For each group of computing systems, the analytic software patch management mechanism then bundles one or more software patches from the set of software patches to be applied to that group of computing systems (step 512).

The analytic software patch management mechanism then applies an associated bundle of software patches to each group of computing systems (step 514). In applying the each bundle of software patches to each of the groups of computing systems, the analytic software patch management mechanism monitors and/or receives feedback analytics, which are stored in an historical analytics data structure (step 516). During the application of the bundles of software patches, the analytic software patch management mechanism determines whether an indication of an external event is indicated during the current maintenance window (step 518), such as, for example, a transformational event, a transient event, a modification event, detection of a change of software or hardware on a computing system, power outages, periods of unusually high network activity, a network failure, or the like.

If at step 518 the analytic software patch management mechanism identifies an indication of an external event during the current maintenance window, then the analytic software patch management mechanism may adjust one or more of the bundles of software patches for the computing systems associated with the external event (step 520), with the operation returning to step 514. If at step 518 the analytic software patch management mechanism fails to determine an indication of an external event during the current maintenance window, the analytic software patch management mechanism determines whether all of the software patches have been applied to all of the computing systems for which software patches were scheduled to have software patches applied (step 522). If at step 522 the analytic software patch management mechanism determines that not all software patches have been applied, then the operation returns to step 514. If at step 522 the analytic software patch management mechanism determines that all software patches have been applied, then the operation terminates.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for applying a maximum number of software patches to a computing system in a minimum amount of time. Using an analytics based approach, the mechanisms automatically group a set of software patches and a set of target computing systems based on historical and real-time data to receive the set of software patches to ensure maximum application of software patches across a maximum number of target computing systems in a minimum amount of time. Additionally, external events are monitored and processed to further improve the trustworthiness of the analytical data.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method, in a data processing system, for applying a maximum number of software patches to each computing system in a set of computing systems in a maintenance window, the method comprising:
grouping, by a processor in the data processing system, a set of computing systems into a plurality of computing system groups based on characteristics associated with each computing system, the plurality of computing system groups comprising at least two different groups of computing systems that differ in implementation of previous software patches;
for each group of computing systems, bundling, by the processor, a set of pending software patches based on characteristics associated with that group of computing systems thereby forming a plurality of bundles of pending software patches, wherein the plurality of bundles of pending software patches comprises at least two different sets of pending software patches; and
for the plurality of computing systems, applying, by the processor, an associated bundle of pending software patches to an associated group of computing systems.

2. The method of claim 1, wherein the characteristics associated with each computing system indicates at least one of a time required to install each of a previous set of software patches to the computing system, specifications associated with the computing system, network bandwidth to the computing system, or communication connections open to the computing system.

3. The method of claim 1, wherein the bundling of the set of pending software patches for application to a particular group of computing systems is affected by an external event occurring since a last maintenance window.

4. The method of claim 1, wherein the associated bundle of pending software patches is modified during application of the bundle of software patches due to an external event occurring during a time in which the associated bundle of pending software patches is being applied to the associated group of computing systems.

5. The method of claim 1, wherein the bundling of the set of pending software patches for application to a particular group of computing systems is based on at least one of an estimated run time on the particular group of computing systems, an importance of each of the pending software patches, any sequencing required by one or more of the pending software patches, or a time in which a pending software patch has been waiting to be implemented.

6. The method of claim 1, wherein a maintenance window time for a particular group of computing systems is estimated based on the set of software patches bundled for that particular group of computing systems.

7. The method of claim 1, wherein a new computing system is grouped into a group of computing systems based on a similarity of characteristics of an existing computing system to characteristics of the new computing system.

8-20. (canceled)
